(19) United States
(12) Patent Application Publication
(10) Pub. No.: US 2013/0045763 A1
(43) Pub. Date: Feb. 21, 2013

(54) SYSTEM AND METHOD FOR PROVIDING NOTICE OF VISITOR

(71) Applicant: CELLNOCK CORPORATION, Costa Mesa, CA (US)

(72) Inventor: David M. Ruiz, Costa Mesa, CA (US)

(73) Assignee: CELLNOCK CORPORATION, Costa Mesa, CA (US)

(21) Appl. No.: 13/661,595

(22) Filed: Oct. 26, 2012

Related U.S. Application Data
(63) Continuation of application No. PCT/US2011/034339, filed on Apr. 28, 2011.

(51) Int. Cl. H04W 4/20; H04W 88/02

(52) U.S. Cl. 455/466; 455/575.1

(57) ABSTRACT

A system for identifying presence of a visitor has a local device (10) to be activated by the visitor, connected to a remote device (40) via a communication link (300). The remote device receives data from the local device such that a user with the remote device is notified of the visitor's presence at the local device, and can optionally communicate with the visitor and/or control the local device through the communication link.

### RELATED APPLICATIONS

This application claims the benefit of U.S. Provisional Application Ser. No. 61/329,019, filed Apr. 28, 2010, and priority to PCT Application Serial No. PCT/US2011/034339, filed Apr. 28, 2011, the contents of which both are incorporated herein by reference.

### BACKGROUND

Currently typical homes have a doorbell for a visitor to activate, and the resident then responds to the doorbell noise by coming physically to the door. The resident then typically views the visitor through a peephole or window, asks “Who is it?” or simply opens the door. Some homes and other buildings have closed circuit television (CCTV) and/or an intercom to allow the resident, security guard, etc., to view the visitor and/or speak to the visitor using local wired networks. However, there is no known system to notify the resident of the presence of a visitor by communicating such presence to the resident via a communication network to a portable device such as a cell phone.

### SUMMARY

This invention includes a local device that functions as a “door bell” for use in combination with a remote device functioning as a visitor identification/screening tool. In a first embodiment, the local device typically includes an inside portion (e.g., a first cell phone) securely but removably mounted to the inside of a door, connected through the door to an outside portion accessible to visitors, which includes a microphone, camera, activation button, speaker, sensors, and/or power cells. In a second embodiment, the local device is contained within a housing or the like, and mounted so as to be accessible to visitors, such as on the outside of a door or on an exterior wall adjacent a door. There is no inside portion in this embodiment.

The remote device is typically a second cell phone. Application software installed on the local and remote devices enables communications between the two, including typical cellular communications and optionally customized communications such as controlling how notifications/calls from the local device to the remote device are handled, and how options are set, maintained, etc.

This invention is envisioned to serve the function of a typical door bell and/or peep hole, in which a visitor announces his presence and the resident then confirms same. But this invention is much more robust, and allows the resident to be aware of, see, hear, and communicate with the visitor, even when the resident is not at the location where the visitor announces his presence. The resident can be in a separate room at the location, or driving, out shopping, golfing, and even completely out of the state or country. The invention allows the resident to be alerted of the presence of a visitor just as if the resident was home and heard the visitor ring the doorbell.

A resident can use the invention to answer his door from a “remote” location. For example, if he is home but unavailable to answer his front door when a visitor arrives, or even if he is away from home, the invention allows him to answer the door via a remote device (e.g., a cellular phone). The remote device refers to a device other than the local device, but the remote device does not necessarily have to be at a location different than the local device. For example, the resident can be at home when the local device at home is activated. The resident can also screen visitors without actually “answering” the door.

The basic communication from the local device to the remote device may be enabled by the resident's existing cellular service provider. The communications may also be enabled using a separate local wireless or wired network.

The examples above refer to a “resident” but the invention is not limited to residential property. Therefore, hereinafter the term “user” will be used to refer to a resident or any other person in a similar position, i.e., the person using the remote device of the present invention.

### BRIEF DESCRIPTION OF THE DRAWINGS

The foregoing and other aspects of embodiments are described in further detail with reference to the accompanying drawings, wherein:

FIG. 1A shows a visitor activating a local device of the present invention;

FIG. 1B shows a user at a remote location (in a car), receiving notice that the local device in FIG. 1A was activated;

FIG. 2 shows a user viewing an inside portion of a local device of the present invention to view an intruder via a camera in an outside portion of the local device;

FIG. 3 shows a local device being charged via a wired connection, while still mounted to the door;

FIG. 4 shows the local device of FIG. 3 being charged when not mounted to the door;

FIG. 5 shows a connection mechanism for connecting an inside portion of a local device to an outside portion of the local device in one embodiment of the present invention;

FIG. 6 shows the local device of FIG. 5, with the inside portion connected to the outside portion;

FIG. 7 shows an exploded perspective view of an alternative embodiment of a local device, having a mounting bracket for mounting an inside portion;

FIG. 8 shows a partially exploded perspective view of the outside portion of the local device of FIG. 7;

FIG. 9 shows a cross sectional view of a local device such as the local device of FIG. 8, mounted to a door;

FIG. 10 shows a perspective rear view of the outside portion of a local device in accordance with an embodiment of the present invention;

FIGS. 11-14 show perspective views of alternate hardware for mounting an outside portion of a local device to an inside portion of the local device in accordance with an embodiment of the present invention;

FIG. 15 shows a side elevation view of an outside portion of a local device, with a cross sectional view of the mounting hardware shown in FIG. 10;

FIG. 16 shows an exploded rear perspective view of a local device with an alternate mounting hardware and electrical charging port;

FIG. 17 shows the local device of FIG. 16 with the electrical charging port further positioned for installation;

FIG. 18 shows the local device of FIG. 17 with the electrical charging mechanism engaged;

FIG. 19 shows a side elevation view of an outside portion of a local device, with a cross sectional view of the mounting hardware and an electrical charging port fully assembled;

FIG. 20 shows a side elevation view of a local device, with a cross sectional view of the mounting hardware and electrical wires passing through a wall between the inside portion and the outside portion of the local device;

FIG. 21 shows a local device (or remote device), not mounted, with the view screen displaying an interface for programming options for user settings;

FIG. 22 shows a remote device with the view screen displaying an image transmitted from a local device, as well as response options;

FIG. 23 shows a block diagram of a local device having an inside portion and an outside portion connected to a remote device via a communication network;

FIG. 24 shows a block diagram of a local device having an outside portion but no inside portion, connected to a remote device via a communication network;

FIGS. 25A-25C are block diagrams showing various means of programming a local device through a VoIP or Internet connection, namely from the local device itself (FIG. 25A), from the remote device (FIG. 25C), or from a computer other than the local device or remote device (FIG. 25B);

FIGS. 26A-26C are block diagrams showing various means of programming a local device through a cellular provider network, namely from the local device itself (FIG. 26A), from the remote device (FIG. 26C), or from a computer other than the local device or remote device (FIG. 26B);

FIG. 27 is a block diagram showing a sample of options on a local device interface for user settings on the local device;

FIG. 28 is a block diagram showing a sample of options on a remote device for user settings on the remote device;

FIG. 29 is a block diagram showing a sample of a user interface on a remote computer for programming the local device;

FIG. 30 is a flowchart showing steps of a method of using a system in accordance with the present invention, in which a visitor activates a local device, then a user is notified of the activation and determines how to handle the notification, including an option for the user to send/forward notice to a second remote device;

FIG. 31 is a flowchart showing steps of a method of using a system in accordance with the present invention, in which a visitor activates a local device, then is presented with an option to leave a recorded message;

FIG. 32 is a flowchart showing steps of a method of using a system in accordance with the present invention, in which a remote device is inactive;

FIG. 33 shows a front exploded perspective view of an alternate embodiment of a local device in accordance with the present invention, in which the local device is contained within a housing to be mounted on an exterior wall or the like;

FIG. 34 shows a front perspective view of the local device of FIG. 33 assembled;

FIG. 35 shows a rear perspective view of a the local device of FIG. 33;

FIG. 36 shows a front exploded perspective view of an alternate embodiment of a local device in accordance with the present invention, in which the local device is contained within a housing to be mounted on the outside of a door;

FIG. 37 shows a rear exploded perspective view of the local device of FIG. 36, along with a wire connector for the local device to be connected to a power source;

FIG. 38 shows a front perspective view of the local device of FIG. 36 assembled;

FIG. 39 shows a side cross-section of a local device contained within a housing, mounted on an exterior wall, with a speaker contained within the frame;

FIG. 40 shows a side cross-section of a local device contained within a housing, mounted on a door, with a speaker contained within the frame;

FIG. 41 shows a side cross-section of a local device contained within a housing, mounted on a door, without a speaker.

### DETAILED DESCRIPTION

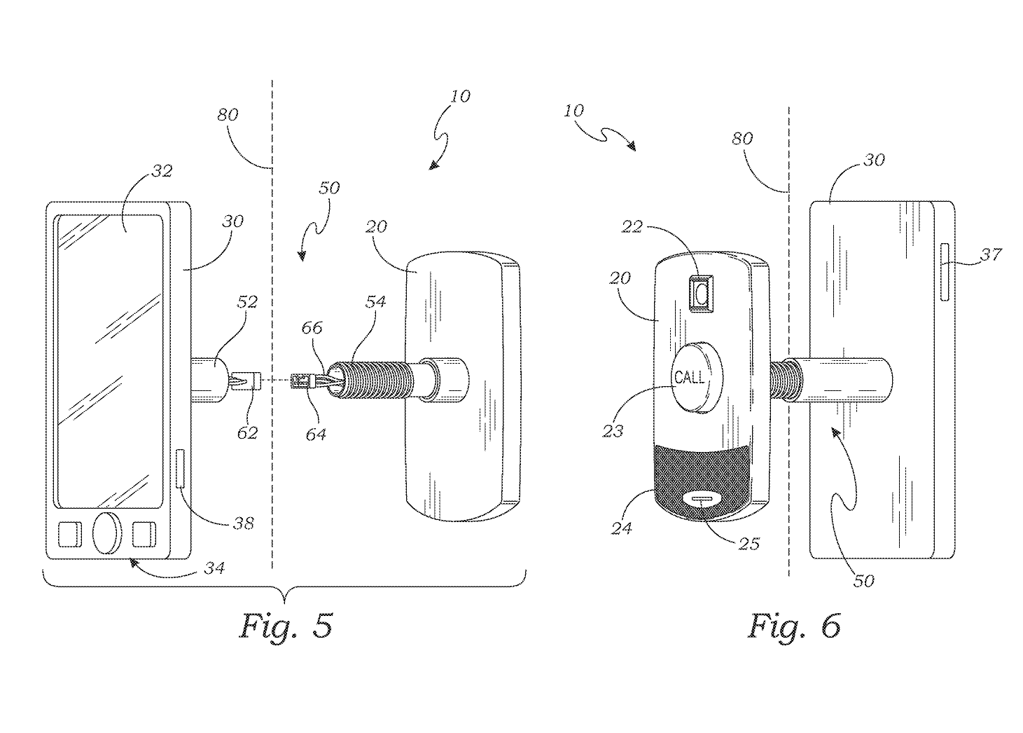

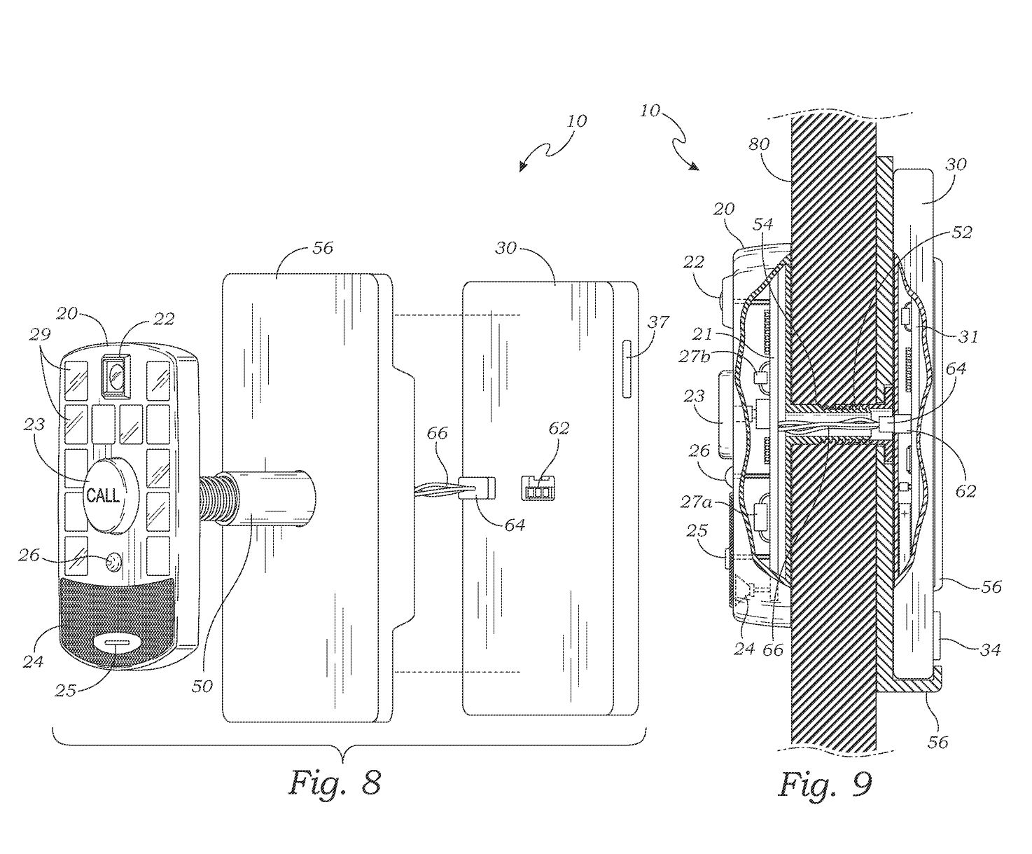

One embodiment of the present invention includes a local device (10) for identifying presence of a visitor (101). The local device (10) includes an outside portion (20) configured for mounting to an outside surface of an object such as a door (80) or a wall (90), an inside portion (30) configured for mounting to an inside surface of the door (80) or wall (90), and a connector (60) connecting the outside portion (20) to the inside portion (30). This embodiment is shown, e.g., in FIGS. 5-9. The connector (60) is configured to be substantially embedded in the door (80) or wall (90) to facilitate the outside portion (20) being securely mounted to the outside surface of the door (80) or wall (90) and the inside portion (30) securely but removably mounted to the inside surface of the door (80) or wall (90). This is shown, e.g., in FIG. 9.

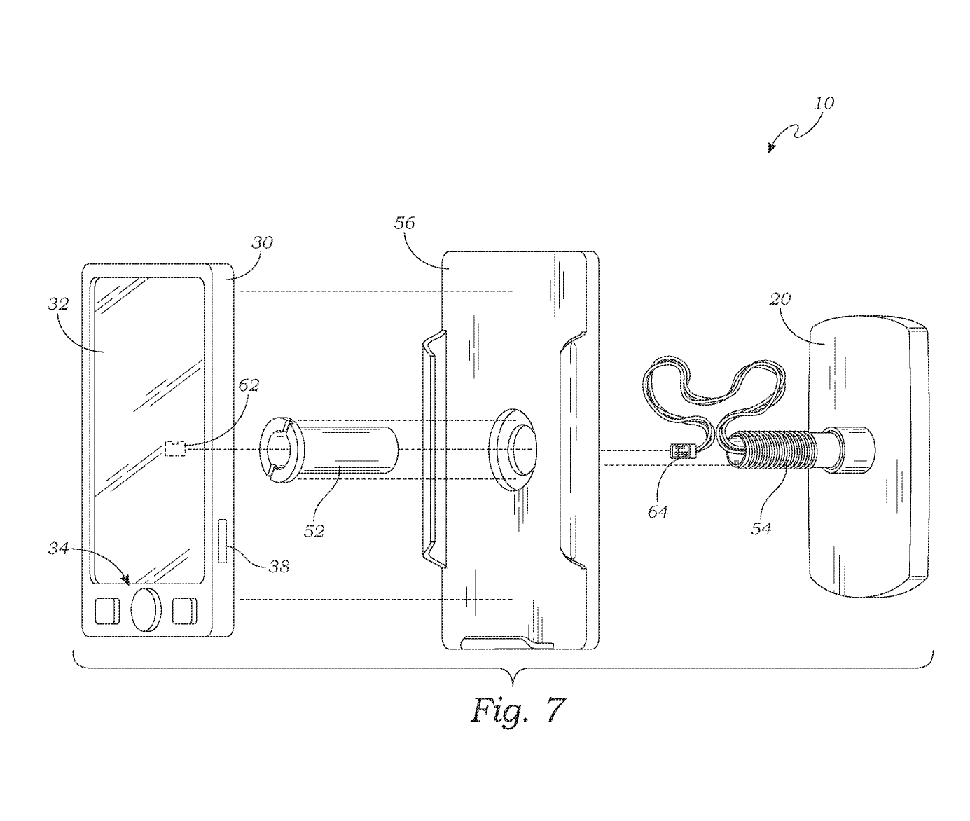

The inside portion (30) typically is a cell phone (see, e.g., FIGS. 5 and 7). The outside portion (20) typically includes an activation mechanism such as a button (23), a motion sensor (26), a vibration sensor (27a), sound sensor (27b), or a combination of the aforementioned. The activation mechanism may be set to notify the remote device (40) similar to the function of a speed dial, in which the local device (10) is programmed to dial or otherwise notify a specified remote device (40). The outside portion (20) may include a speaker (24), a camera (22), and/or a microphone (25), and is operatively connected to the inside portion (30) via the activation mechanism such that activation of the activation mechanism activates the inside portion (30) causing the inside portion (30) to transmit data to a remote device (40) via a communication link (300) such as a cellular phone network and/or the Internet. Additionally or alternatively, the inside portion (30) may set off a local audio alert, such as to mimic a doorbell for example, and may itself display or otherwise communicate the data on location, such as via its own viewing screen. The data may be audio and/or video signals and images captured by the local device (10) at approximately the time of activation. For example, the microphone (25) captures audio (e.g., the visitor's voice), and the camera (22) captures video and/or still images (e.g., of the visitor). Additionally, the data may include system information such as date, time, temperature, bio-metric data, etc. The data may also be sent via SMS text messaging, email, customized treatment options via an application running on the local (30) and/or remote device (40), or any combination of the aforementioned. The outside portion (20) may also include a biometric sensor such as a fingerprint reader or retina scanner, and the data sent may include biometric data. The remote device (40) is typically a second cell phone. The local device (10) may also include a memory with a pre-recorded message, and may be programmed to play the message through the speaker (24) upon activation of the activation mechanism, or in response to a command transmitted to the local device (10) from the remote device (40). In this manner, the visitor (101) may receive a message set or programmed from the local device itself (10) or from the remote device (40), another source such as a PC via a web application, at will or in response to notice that the local device (10) has been activated. The user can be at a remote location, and receive notification that the visitor (101) is present at the local location, including real-time audio, photo, video, and/or biometric data from the local location.

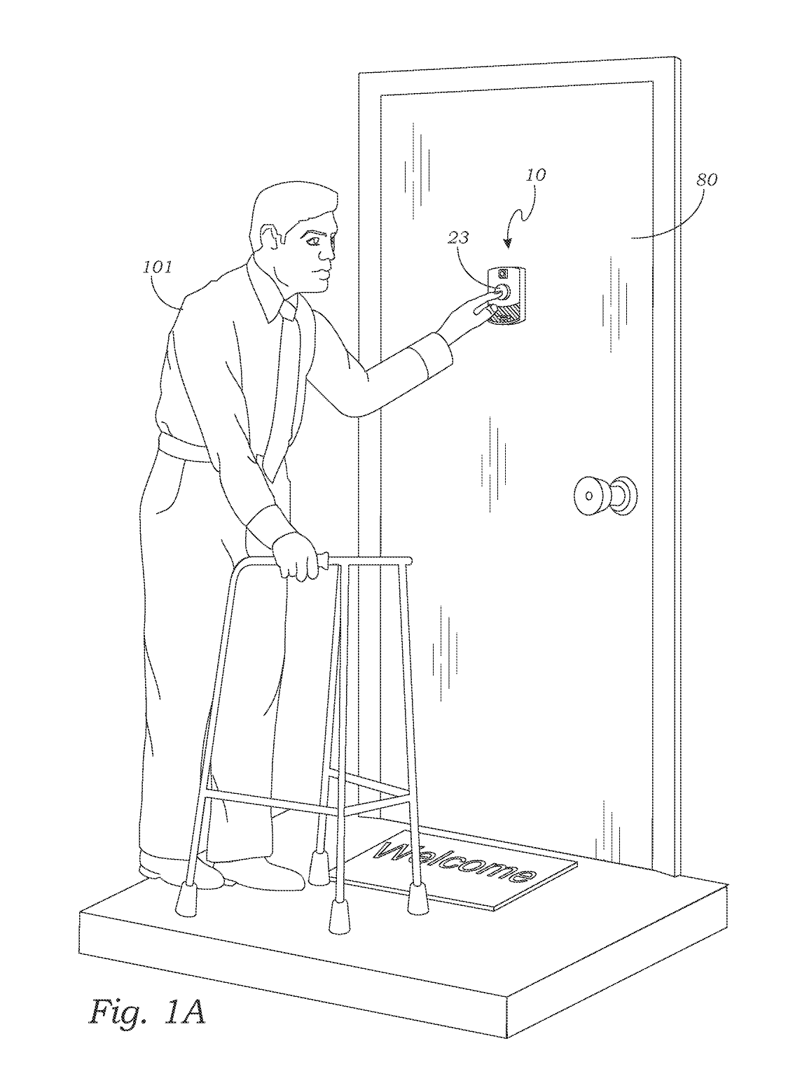

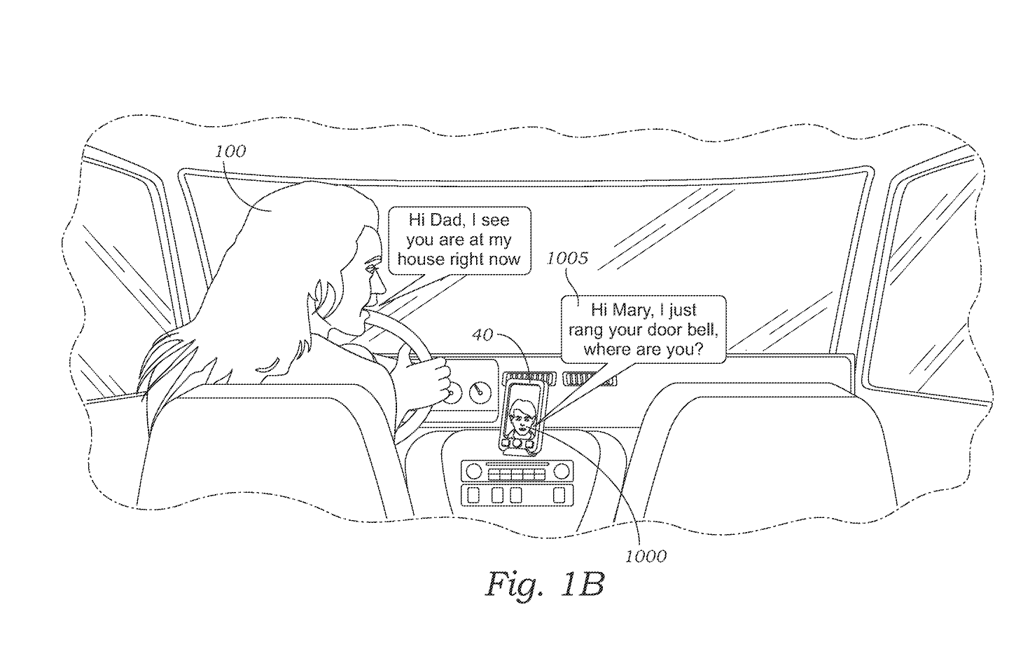

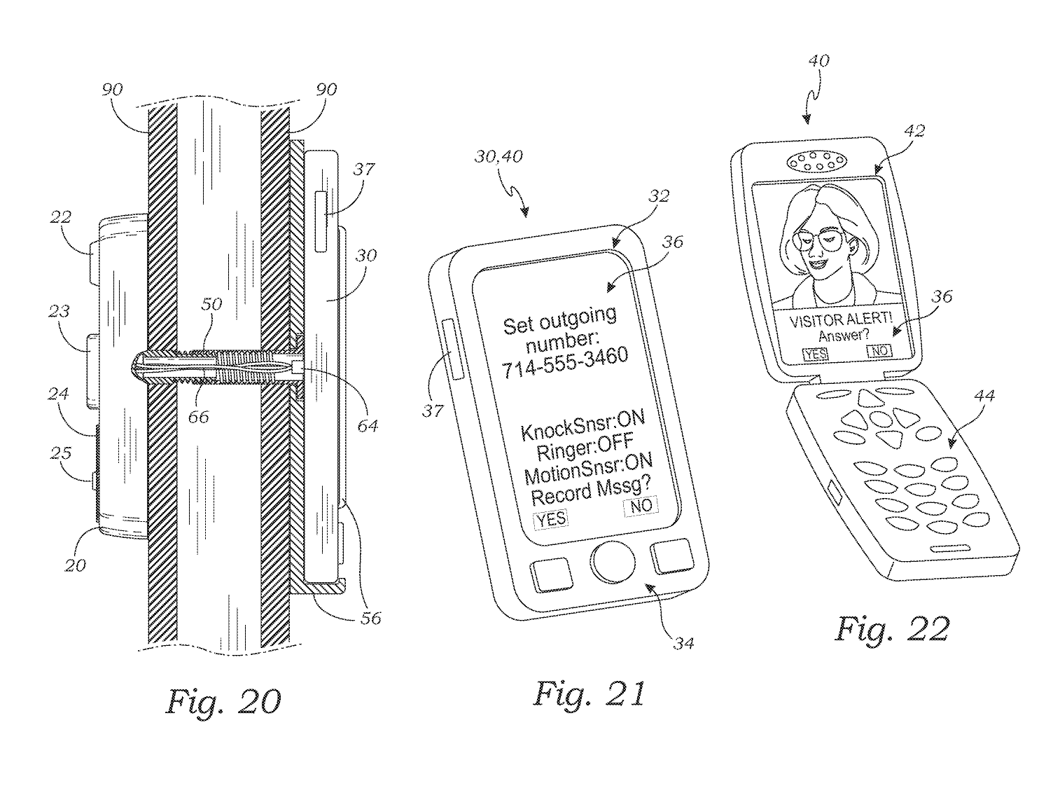

The local device is typically mounted to a door (80) as seen in FIGS. 1A, 2, and 9, or to a wall (90) as seen in FIG. 20. The outside portion (20) should be securely mounted to the outside of the door (80). The inside portion (30) should be securely mounted to the inside surface of the door (80), but removable from the mounting to allow easy transport of the inside portion (30) for charging, storing, maintaining, and use at other locations besides the backside of the door (80), such as in another room at the location. The functionality of the invention is not affected depending on where the local device (10) is mounted, but the mounting hardware (50) will vary according to the mounting surface.

Turning to FIG. 9, a cross sectional view of a local device (10) is shown mounted to a door (80). The outside portion (20) is mounted to the outside of the door (80) via a bracket (56), which is physically connected to the inside portion (30) using a threaded cylinder (54) embedded in the door (80) and connected to a corresponding cylindrical receiving connector (52) threaded oppositely. The outside portion (20) of the local device (10) is electrically connected to the inside portion (30) via wired connection that includes wire (66), and wire connection ports (62) and (64), or BLUETOOTH or other WiFi connection. FIG. 6 shows the local device (10) of FIG. 5, with the inside portion (30) connected to the outside portion (20). In this embodiment, the outside portion (20) includes a button (23) as the activation mechanism, a camera (22), a speaker (24), and a microphone (25).

The outside portion (20) includes an activation mechanism. In FIG. 9, this is shown as a button (23), a motion sensor (26), and/or a vibration sensor (27), all of which may be used independently or in combination. The outside portion (20) also includes camera (22) which may be a still camera, a video camera, or combination camera, with or without audio, a microphone (25) for capturing audio at the local location, and a speaker (24) for outputting audio at the local location.

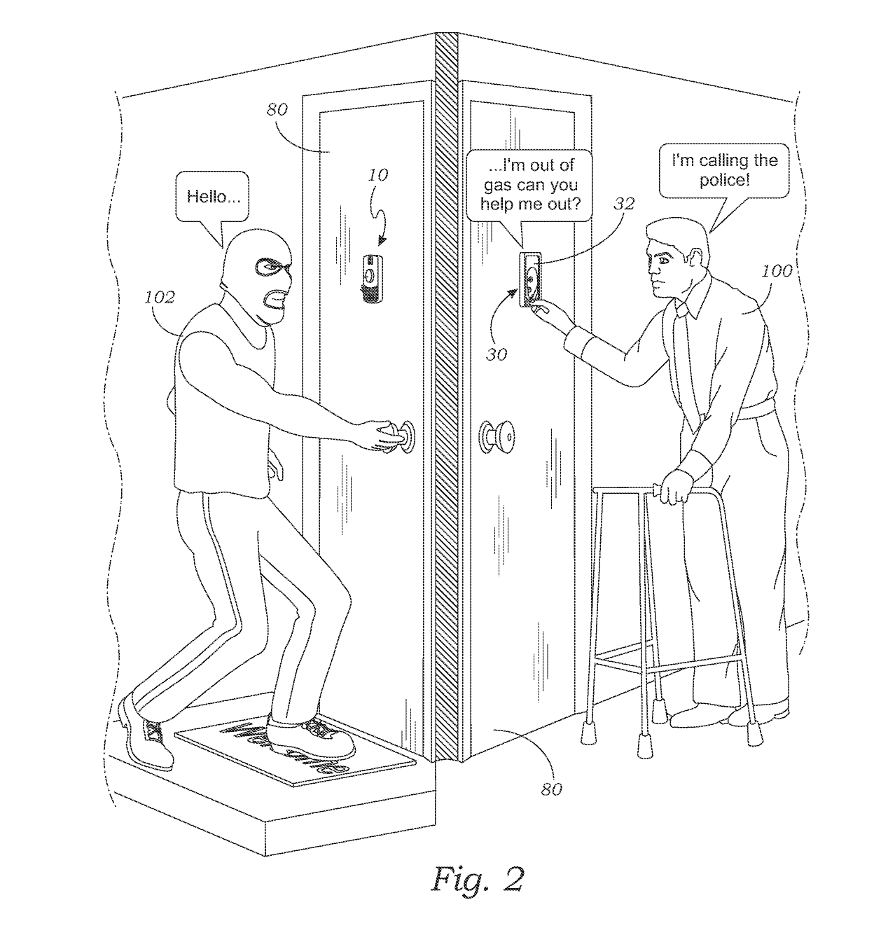

Turning now to FIGS. 1A-2, these figures show examples of the system of the present invention in actual use. FIG. 1A shows a visitor (101) activating the actuation mechanism of the local device (10) which in this example is a button (23). The local device (10) is shown mounted to a door (80). FIG. 1B shows a user (100) at a remote location (in a car), receiving notice on the remote device (40) that the local device (10) in FIG. 1A was activated. The notification appears in the form of a video image (1000) and audio (1005), both corresponding to the visitor (101) of FIG. 1A. FIG. 2 shows a different example, this time of an unwanted visitor such as an intruder (102), with the user (100) viewing a view screen (32) on the inside portion (30) of the local device (10) to be able to see the visitor (102) is a bad guy. This embodiment with the inside portion (30) may include data being sent from the outside portion (20) to the inside portion (30) and the remote device (40) in parallel, or to the inside portion (30) then the remote device (40) serially.

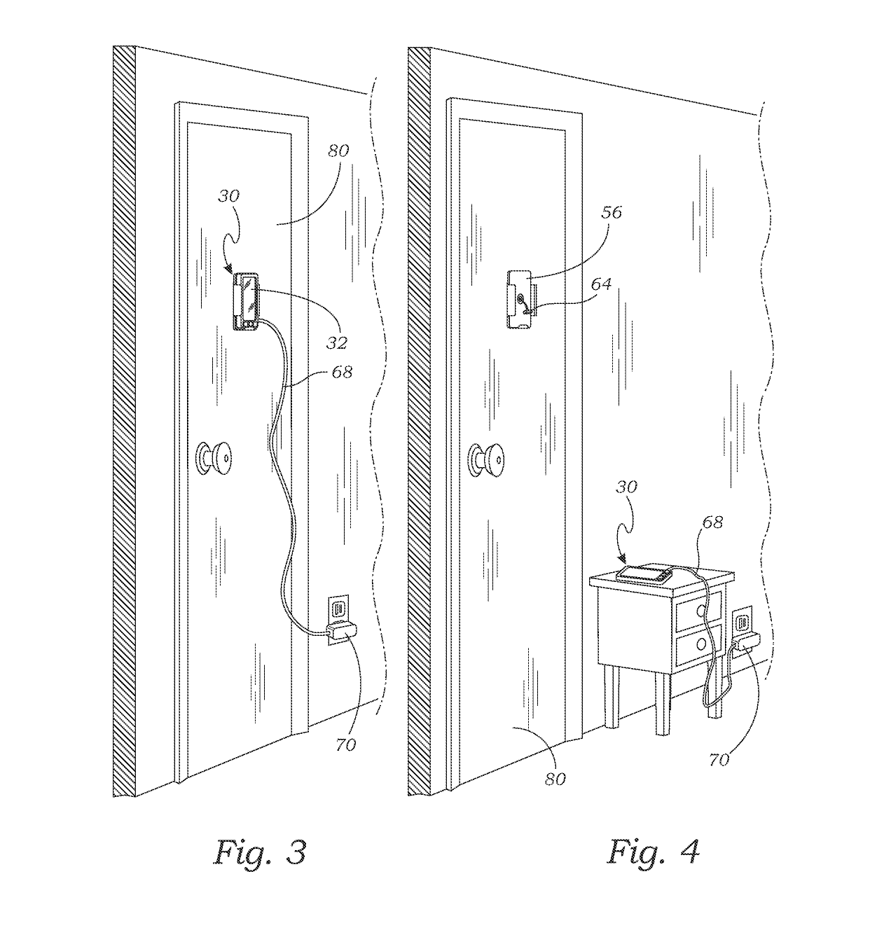

FIGS. 3-4 show the inside portion (30) of a local device (10) being charged via a wired connection (68), while still mounted to the door (80). FIG. 4 shows the local device (10) of FIG. 3 being charged when not mounted to the door (80), but the bracket (56) remains on the door (80). In this manner, the inside portion (30) is securely but removably mounted to the door (80).

Turning now to FIGS. 7-9, an alternative embodiment of a local device (10) is shown, having a mounting bracket (56) for mounting the inside portion (30). FIG. 7 shows an exploded view of the inside portion (30). FIG. 8 shows a partially exploded perspective view of the outside portion (20) of the local device (10) of FIG. 7. This embodiment includes solar cells (29) for charging the local device (10) or for charging just the outside portion (20) or inside portion (30). FIG. 9 shows a cross sectional view of a local device (10) such as the local device of FIG. 8, mounted to a door (80), and has been described herein.

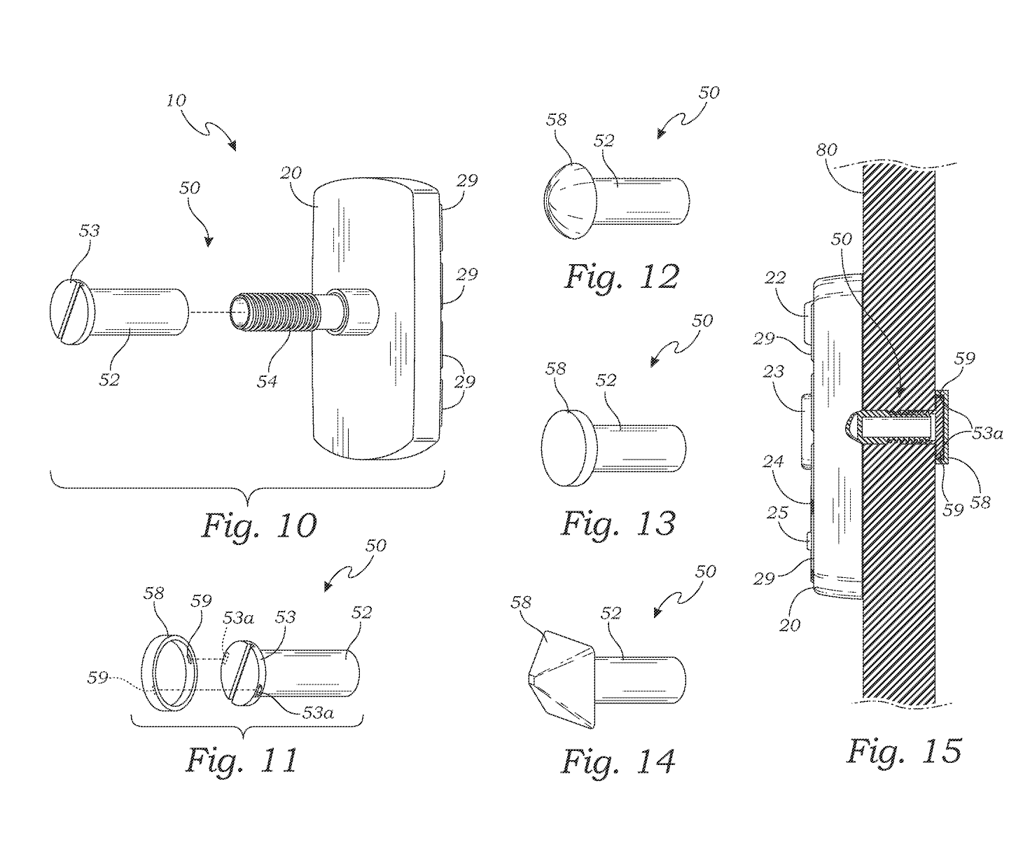

Turning now to FIGS. 10-14, various embodiments of mounting hardware (50) are shown for mounting the outside portion (20), in embodiments of the local device (10) that do not include an inside portion (30). FIG. 10 shows a perspective rear view of the outside portion (20), with connector (52) having a capped end (53) with a slot configured for rotation by a flathead screwdriver or other suitable tool. FIG. 11 shows a similar connector (52) in which the capped end (53) includes indents (53a) for receiving detents (59) on a cover ring (58) for further protecting capped end (53). FIGS. 12-14 show other embodiments of cover ring 58 which include additional protection in the form of various-shaped caps. FIG. 15 shows a side elevation view of an outside portion (20), with a cross sectional view of the mounting hardware (50) shown in FIG. 10, including the ring (58) of FIG. 11.

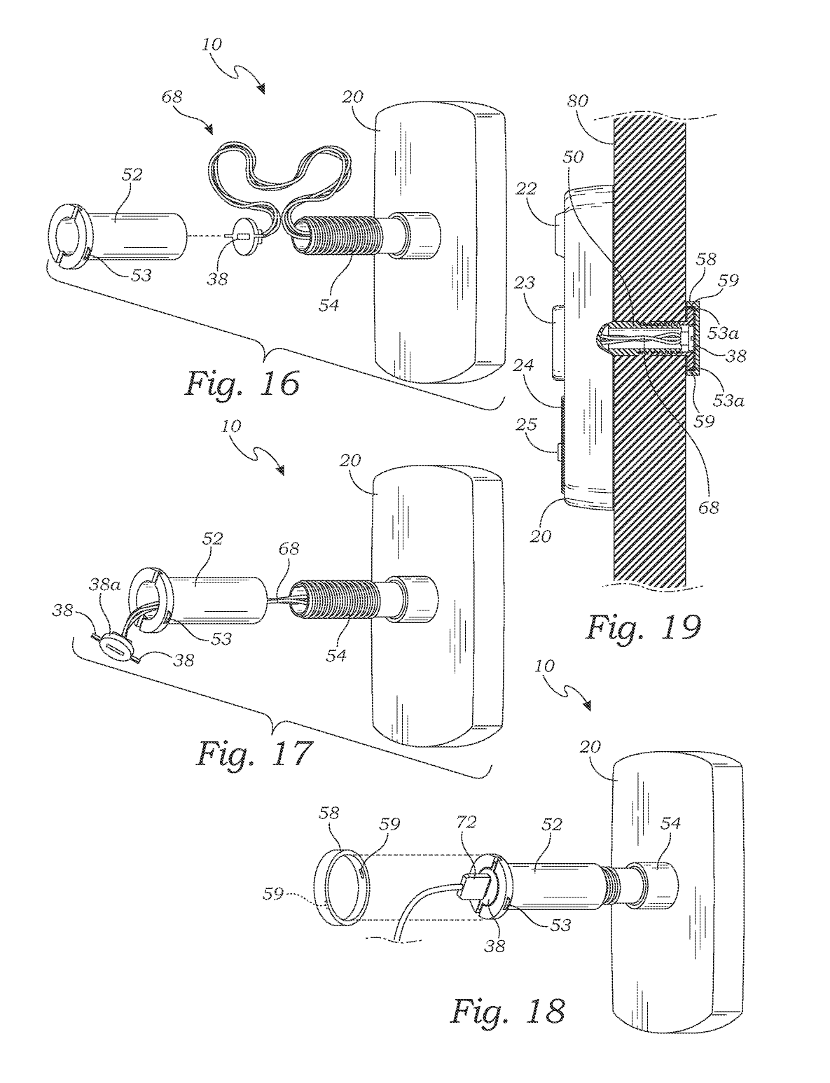

Turning now to FIGS. 16-19, an outside portion (20) is shown with a charging port (38) designed to be accessible from the inside of the mounting object (door (80) or wall (90)). This is for embodiments that do not include an inside portion (30). FIG. 16 shows a rear exploded perspective view of the local device (10) (in this case just the outside portion (20)). FIG. 17 shows the local device (10) of FIG. 16 with the electrical charging port (38) further positioned for installation. The port (38) may have tabs (38a) for securing port (38) into receiving connector (52). FIG. 18 shows the local device (10) of FIG. 17 with the electrical charging port (38) engaged by connector (72) of charger (70) (see FIGS. 3-4). FIG. 19 shows a side elevation view of an outside portion (20), with a cross sectional view of the mounting hardware (50) and an electrical charging port (38) fully assembled.

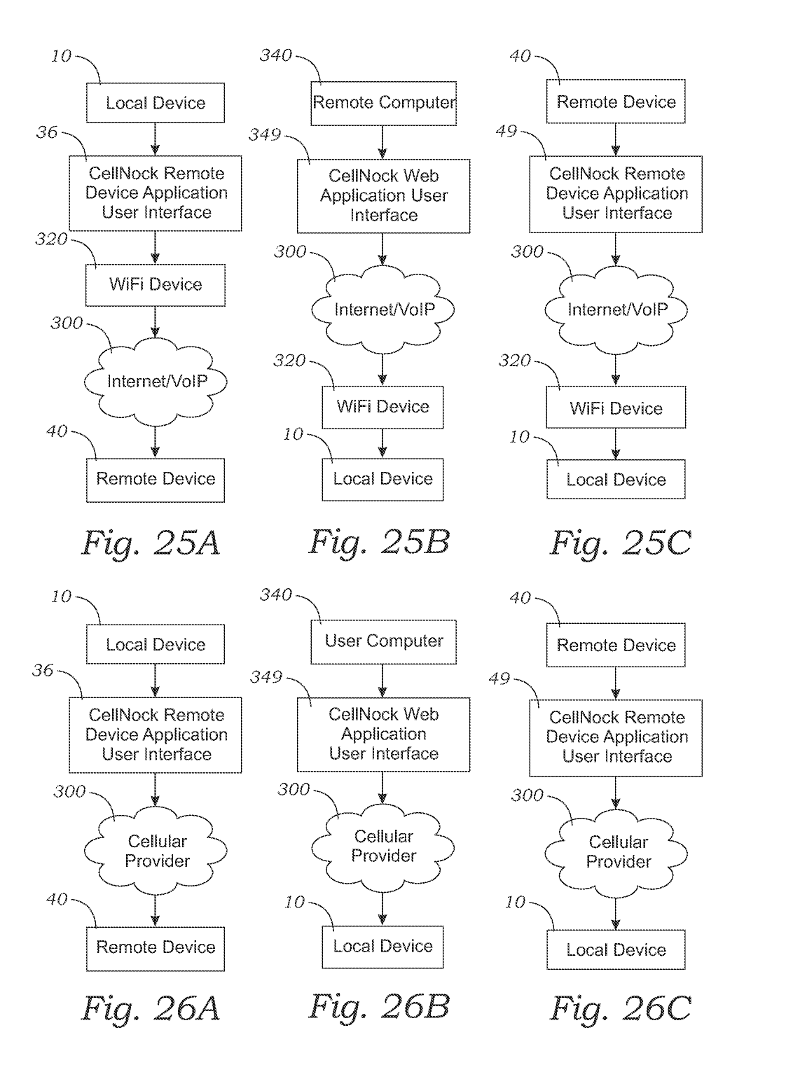

FIG. 20 shows a side elevation view of a local device (10), with a cross sectional view of the mounting hardware (50) and electrical wires (66) passing through a wall (90). In this embodiment, the local device has an inside portion (30) and an outside portion (20). The wires (66) electrically connect the inside portion (30) to the outside portion (20). Turning to FIG. 21, an inside portion (30) of a local device (10) is shown not mounted, with the view screen (32) displaying an on-screen interface (36) for programming options for user settings. The device shown may also be a remote device (40), as the programming interface may be useable from either an inside portion (30) or a remote device (40). See also FIGS. 25A-25C which are block diagrams of various means of programming a local device (10) through a VoIP or Internet connection (300), namely from the inside portion (30) of the local device (10) itself (FIG. 25A), from the remote device (30) (FIG. 25C), or from a computer (340) other than the inside portion (30) or remote device (20) (FIG. 25B). Likewise, FIGS. 26A-26C are block diagrams showing various means of programming the local device (10) through a cellular provider network (300), namely from the inside portion (30) of the local device (10) itself (FIG. 26A), from the remote device (40) (FIG. 26C), or from a computer (340) other than the inside portion (30) or remote device (40) (FIG. 26B). These figures are discussed further herein. FIG. 22 shows a remote device (40) with the view screen (42) displaying an image of a visitor (101) transmitted from a local device (10), and response options via user interface (36).

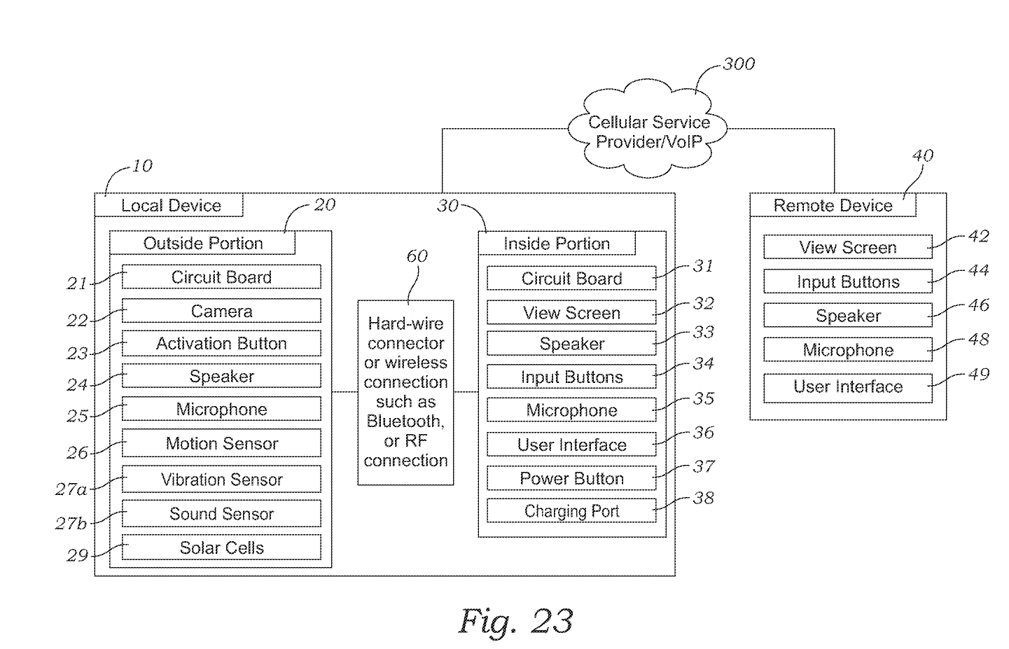

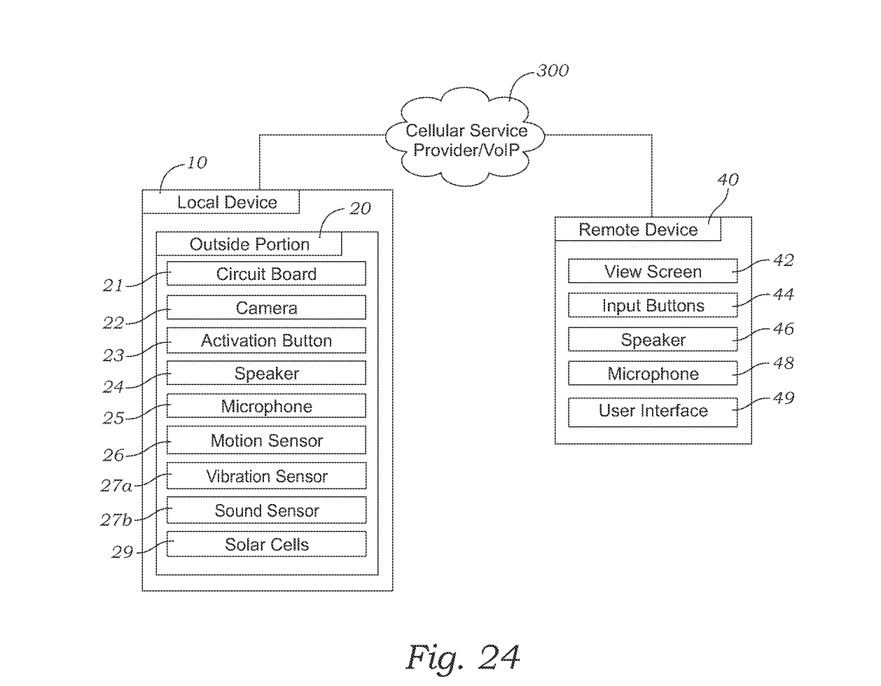

Turning now to FIG. 23, a block diagram is shown of a local device (10) having an inside portion (30) and an outside portion (20) connected to a remote device (40) via a communication network (300). The outside portion (20) includes camera (22), activation button (23), speaker (24), microphone (25), motion sensor (26), vibration sensor (27a), sound sensor (27b), and solar panels (29). Many of these components are optional as discussed herein. Outside portion (20) also includes circuit board (21) with CPU for controlling communications, data transfer, user interfaces, power, etc. The outside portion (20) is linked to inside portion (30) via link (60) which may be hardwired or wireless. Inside portion (30) includes circuit board (31), view screen (32), speaker (33), input buttons (34), microphone (35), user interface (36), power button (37), and charging port (38). Communication network (300) allows communication between the local device (10) and the remote device (40). The remote device (40) includes view screen (42), input buttons (44), speaker (46), microphone (48), and user interface (49). FIG. 24 shows a block diagram of a local device (10) having an outside portion (20) but no inside portion (30).

Referring back now to FIGS. 25A-25C, these are block diagrams of various means of programming a local device (10) through a VoIP or Internet connection (300), namely from the inside portion (30) of the local device (10) itself (FIG. 25A), from the remote device (30) (FIG. 25C), or from a computer (340) other than the inside portion (30) or remote device (20) (FIG. 25B). For example, FIG. 25A shows a local device (10) being used to access and program a remote device (40) via a WiFi connection (320) to the Internet (300). The programming interface (49) on the remote device (40) is used to set various options such as whether to have the local device (10) send audio and/or video, whether to play a pre-recorded message at the local device (10) upon activation, and to which remote device(s) (40) to send the notification of activation. FIG. 25B shows the programming being done from a separate computer (340) which may be a desktop, laptop, IPAD, or other PDA, wherein the programming interface (349) is a web or stand-alone application as opposed to being on the remote device (40). FIG. 25C shows the programming being performed at a user interface (49) at the remote device (40). FIGS. 26A-26C show similar programming alternatives, but using a cellular phone network (300) instead of a VoIP or Internet network (300).

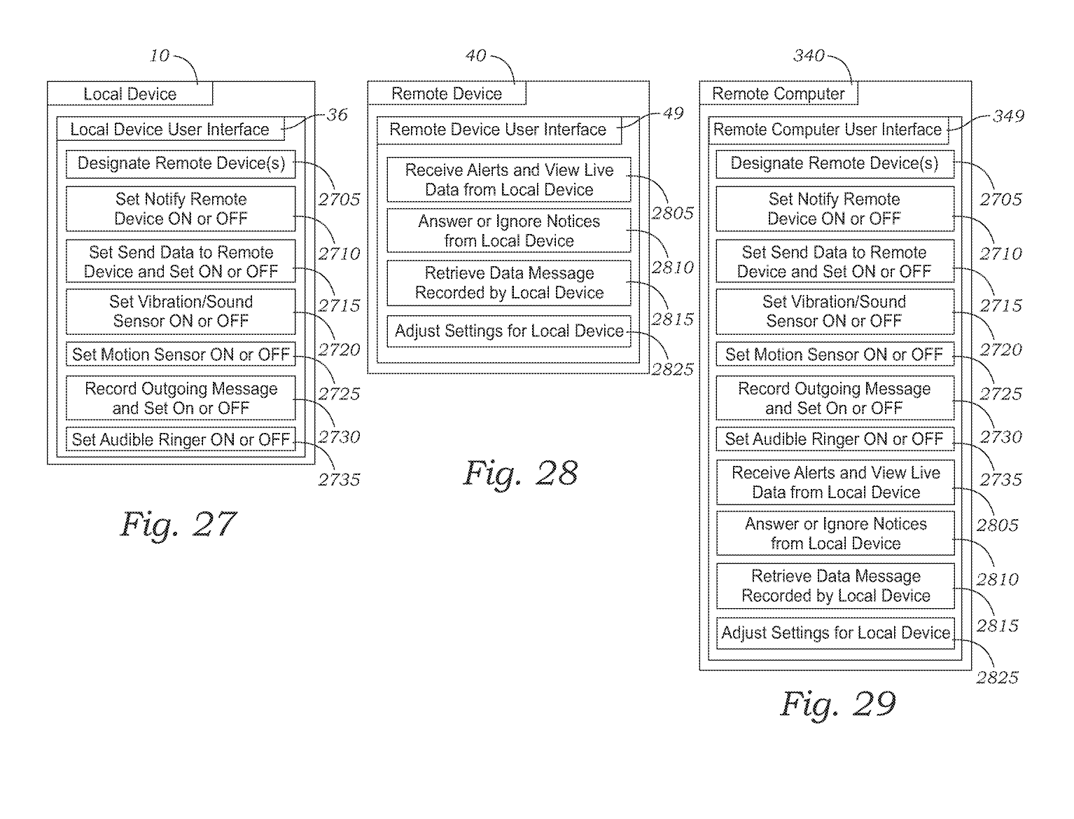

Turning now to FIGS. 27-29, FIG. 27 is a block diagram of a sample of options on the interface (36) of a local device (10) for user settings on the local device (10). The options include: “designate remote devices” (2705); “set notify remote device on or off” (2710); “set send data to remote device and set on or off” (2715); “set vibration sensor on or off (2720); “set motion sensor on or off” (2725); “record outgoing message and set on or off” (2730); and “set audible ringer on or off” (2735). Other customized options may be provided to program, set, diagnose, maintain, etc. the local device (10). FIG. 28 is a block diagram of a sample of options on the user interface (49) of a remote device (40) for user settings on the remote device (40). The options include: “receive alerts and view live data from local device” (2805); “answer or ignore notices from local device” (2810); “retrieve data message recorded by local device” (2815); and “adjust settings for local device” (2820). Other customized options may be provided to program, set, diagnose, maintain, etc. the remote device (40). FIG. 29 shows a block diagram of a sample of a user interface (349) on a remote computer (340) for programming the local device (10). The options include the same options as FIGS. 27-28.

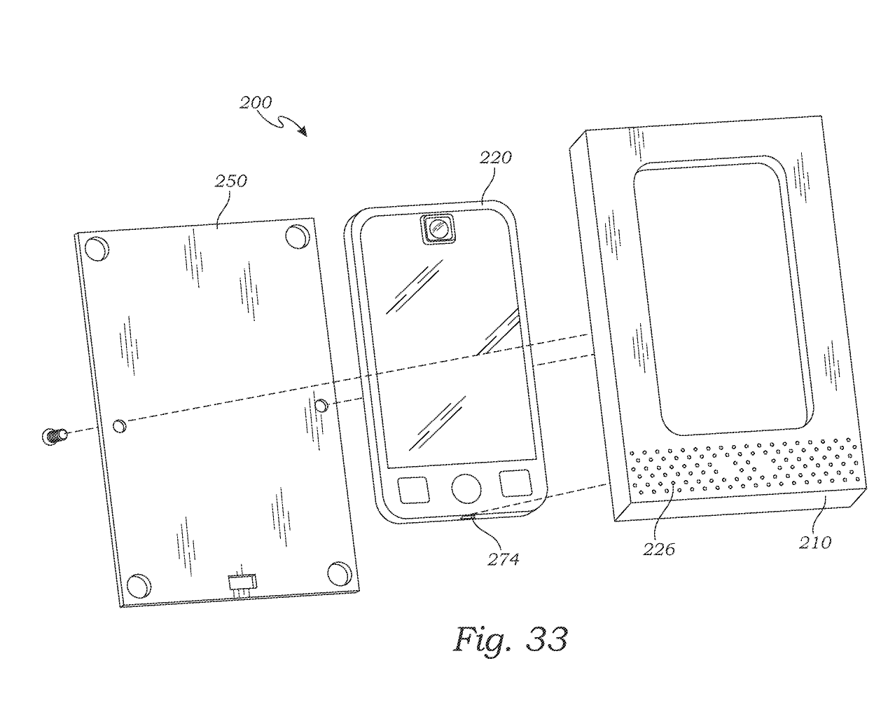

Turning now to FIGS. 33-35, an alternate embodiment of a local device (10) in accordance with the present invention is shown, in which the local device (10) is contained within a housing (200) to be mounted on an exterior wall (90) or the like. FIG. 33 shows a front exploded perspective view of the housing (200), including a substantially rectangular frame (210) with an amplified speaker (226) for amplifying an audio signal from the communication device (220). In this example the communication device (220) is a cell phone. The housing (200) also includes a back plate (250) for securing the communication device (220) within the frame (210), and for mounting the local device (10) to the wall (90). The back plate (250) is configured to be mounted to the back side of the frame (210) so that the housing (200) may then be mounted to the wall (90) through the back plate (250). The housing (200) also includes a speaker jack (264) for operatively connecting the amplified speaker (226) to an audio signal from the cell phone (220) mounted in the frame (210), via the cell phone's standard port (274). The cell phone (220) has a speaker configured to transmit an audio signal to the amplified speaker (226).

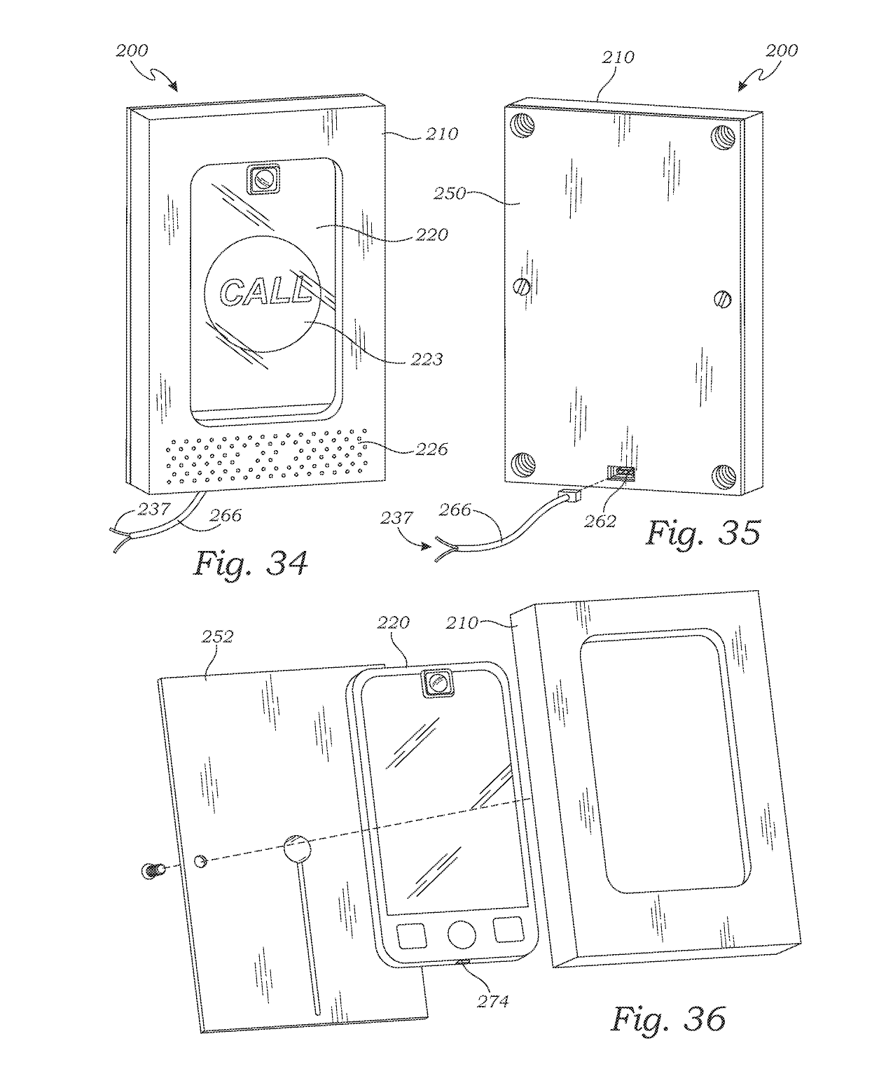

FIG. 34 shows a front perspective view of the housing (200) of FIG. 33, assembled and with a cell phone (220) secured therein. In this embodiment, wire connection (266) having leads (237) is used to electrically connect the local device (10) to a power source (not shown). This embodiment also shows a “CALL” button (223) that is a touch screen icon for activating the local device (10). FIG. 35 shows a rear perspective view of a the local device (10) of FIG. 33, showing the connection port (262) for receiving wire connector (266).

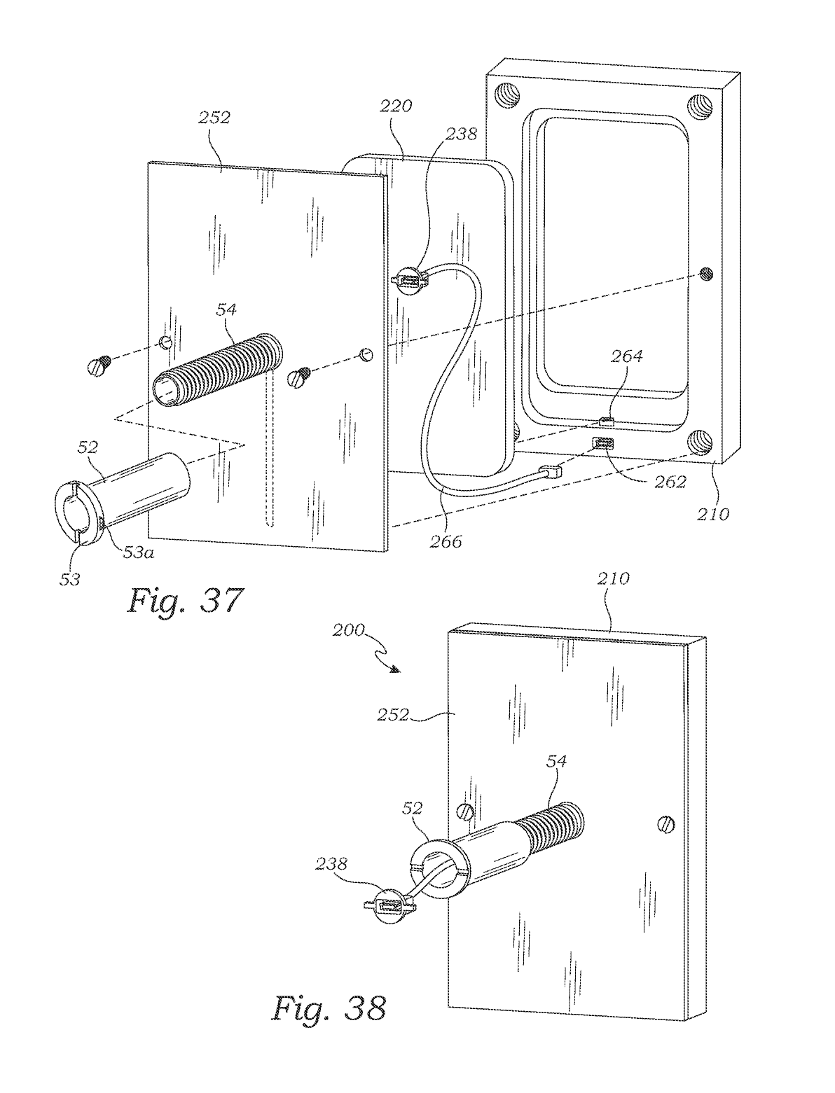

FIGS. 36-38 show an alternate embodiment of a local device (10) contained within a housing (200) to be mounted on the outside of a door (80). This embodiment is similar to the wall-mount embodiment of FIGS. 33-35, except the mounting mechanism is different. For example, there is no port (262) on the back plate (252) because the electrical connection with charging port (238) will instead pass through the threaded cylindrical tube (54) and the corresponding oppositely threaded cylindrical mating portion (52) threaded onto the tube (54), both of which are connected to the back plate (252) and configured to be received by a bore in the door (80). The bore may be the same bore used for a pre-existing peep hole.

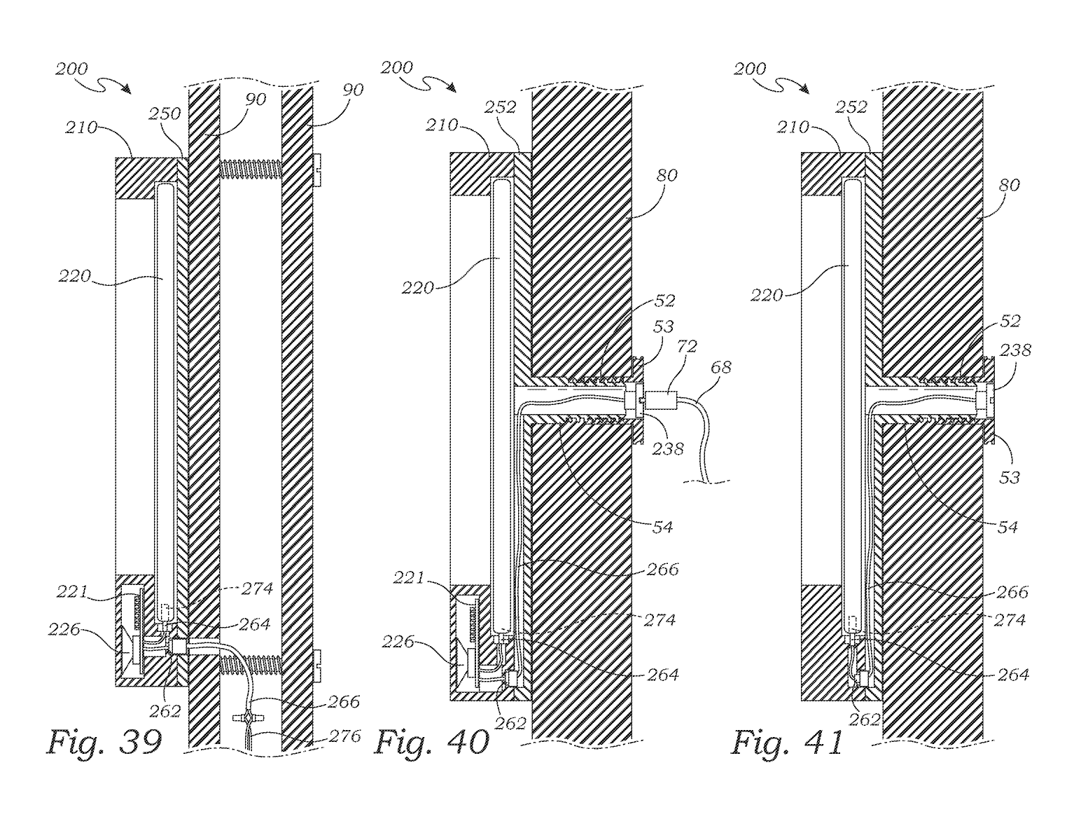

FIG. 39 shows a side cross-section of a local device (10) contained within a housing (200), mounted on an exterior wall (90), with a speaker (226) and power source port (262) contained within the frame (210). Back plate (250) is shown mounted to the wall (90) with bolts. Electrical connection (266) to external power source (276) is also shown. Circuit board (221) is shown connecting amplified speaker (226) and power source (276) to cell phone (220) by power source jack (264) being inserted into the power source port (274) of cell phone (220), such that cell phone (220) does not need a battery. FIG. 40 shows a side cross-section of a local device (10) contained within a housing (200), mounted to a door (80), with a speaker (226) contained within the frame (210). In this embodiment, the wire connection (266) is connected to a removable power source device (70) through mounting hardware (50). FIG. 41 shows the same device as FIG. 40, without an amplified speaker (226) and related components.

A system for identifying presence of a visitor has thus been described herein. The system includes a local device (10), a remote device (40), and a communication link (300) linking the local device (10) to the remote device (40). The local device (10) in one embodiment includes an outside portion (20) securely mounted to an outside surface of a door (80), and an inside portion (30) securely but removably mounted to an inside surface of the door (80), as well as a connector (50) embedded in the door (80) and connecting the outside portion (20) to the inside portion (30). The outside portion (20) includes an activation mechanism and is operatively connected to the inside portion (30) via the activation mechanism such that activation of the activation mechanism activates the inside portion (30) causing the inside portion (30) to transmit data to the remote device (40) via the communication link (300). The outside portion (20) may include a microphone (25), speaker (24), and/or camera (22) as previously described. Various activation mechanisms have also been described, including a mechanical button (23), virtual/touch screen button (223), motion sensor (26), vibration sensor (27a) or sound sensor (27b). In another embodiment, there is no inside portion (30), as described herein.

In practice, a user (100) receives notification of presence of a visitor (101) at a location by receiving notification on a wireless remote device (40), of the visitor (101) having activated the local device (10) at the location. The notification could include data captured by the local device (10) at approximately the time of activation, including audio of the visitor, and/or video and/or still images (1000) of the visitor (101). The remote device (40) has a viewing screen (42). The user (100) may thus view the images (1000). The remote device (40) also has a speaker (46) so the user (100) can thus hear the audio (1005) transmitted. The user (100) is also presented with options on the viewing screen (42) for processing the notification. The user (100) then can enter commands into the remote device (40) to select one or more of the options. Such commands may include a request to initiate a voice communication with the visitor (101) through the communication link (300) linking the remote device (40) to the local device (10). In a typical scenario, this would amount to a standard cell phone conversation in which the visitor (101) is using the cell phone of the local device (10) and the user (100) is using the remote device (40) which is also a cell phone, although this would involve additional management software to control the interfaces of the two devices (10) and (40). Typically, the local device (10) is mounted to a door (80) or a wall (90) at the local location, such as a residence, and in this manner the invention serves as a remote door answering/monitoring system with audio/video capability.

At the location of the local device (10), once the local device (10) has been activated, it is presumed a visitor (101) is present at the location. The local device (10) is typically mounted to a door (80) or a wall (90). The local device (10) may then capture data associated with the visitor (101) at approximately the time of activation, and transmit the data through a wireless network (300) to the remote device (40). Presuming the user (100) desires to start a conversation, the local device (10) would then receive a command from the remote device (40) to establish a communication between the local device (10) and the remote device (40). The communications may then include audio and/or video as described herein.

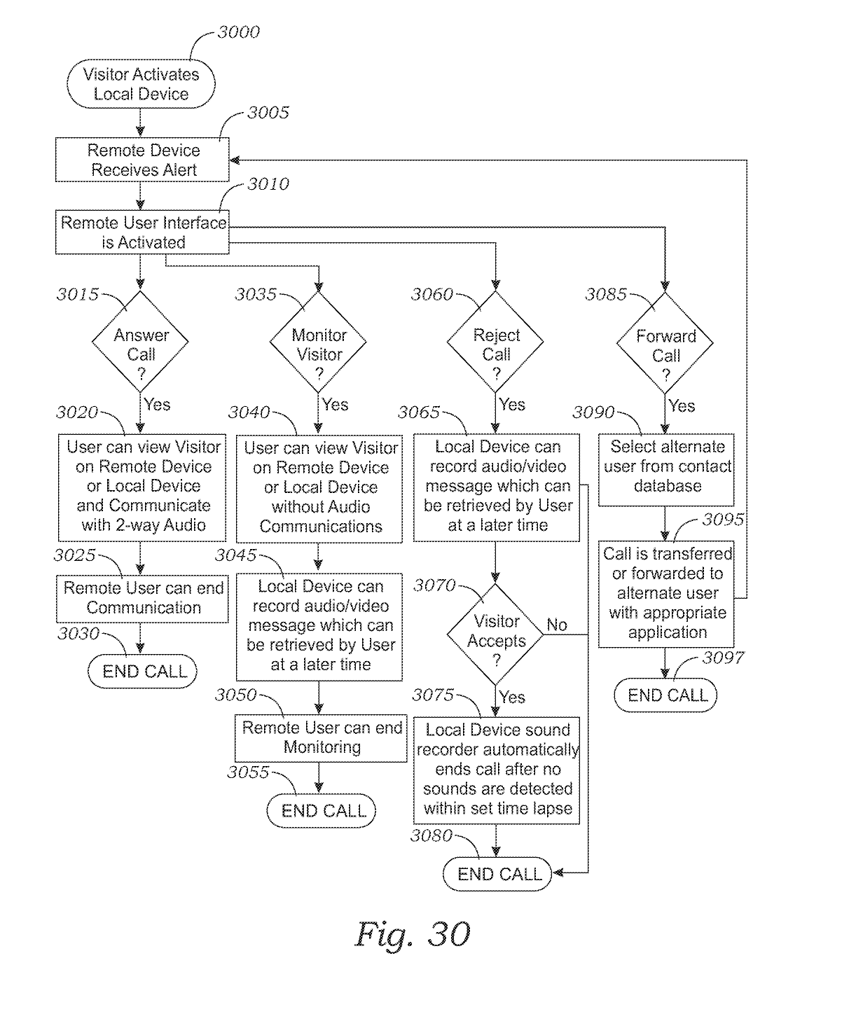

Turning now to FIG. 30, a flowchart is shown indicating steps of a method of using a system in accordance with the present invention, in which a visitor activates a local device, then a user is notified of the activation and determines how to handle the notification, including an option for the user to send/forward notice to a second remote device. The method begins at step 3000 when the visitor activates the local device. The remote device then receives an alert at step 3005, and the remote user interface is activated at step 3010. In this example, the interface includes four separate options. The user may either answer the call (3015), monitor the visitor (3035), reject the call (3060), or forward the call (3085).

If the user answers the call (3015), the user then can view data on the remote device or inside portion of the local device as described herein, and establish 2-way audio communication. The user can then end the communication as seen at step (3025), in which case the method ends (3030).

If the user chooses to monitor the visitor (3035), the user can view and/or listen to the visitor on the remote device or inside portion of the local device (3040), without establishing 2-way communication. The local device may record audio, and/or video data associated with the visitor (3045), which can then be retrieved by the user at a later time. Other data may also be recorded and/or stored, such as date, time, and biometric data. The user can end the monitoring (3050), in which case the method ends (3055).

If the user chooses to reject or ignore the call (3060), the local device may still record audio, and/or video data associated with the visitor (3065), which can then be retrieved by the user at a later time. In this case, the visitor may be presented with an option of whether to authorize the recording (3070), and if so the recording would occur (3075), and the recording would thereafter end (3080). If the visitor did not authorize such recording, the method would end at that time (3080).

If the user chooses to forward the notification to an alternate device or devices (3085), the user may select which device or devices (3090), and the notification/call is then transferred to such devices (3095). The method then ends (3097) and the call takes place between the visitor and a person controlling the alternate device(s).

Other options may also be available and can be programmed into the application software depending on the requirements of various systems.

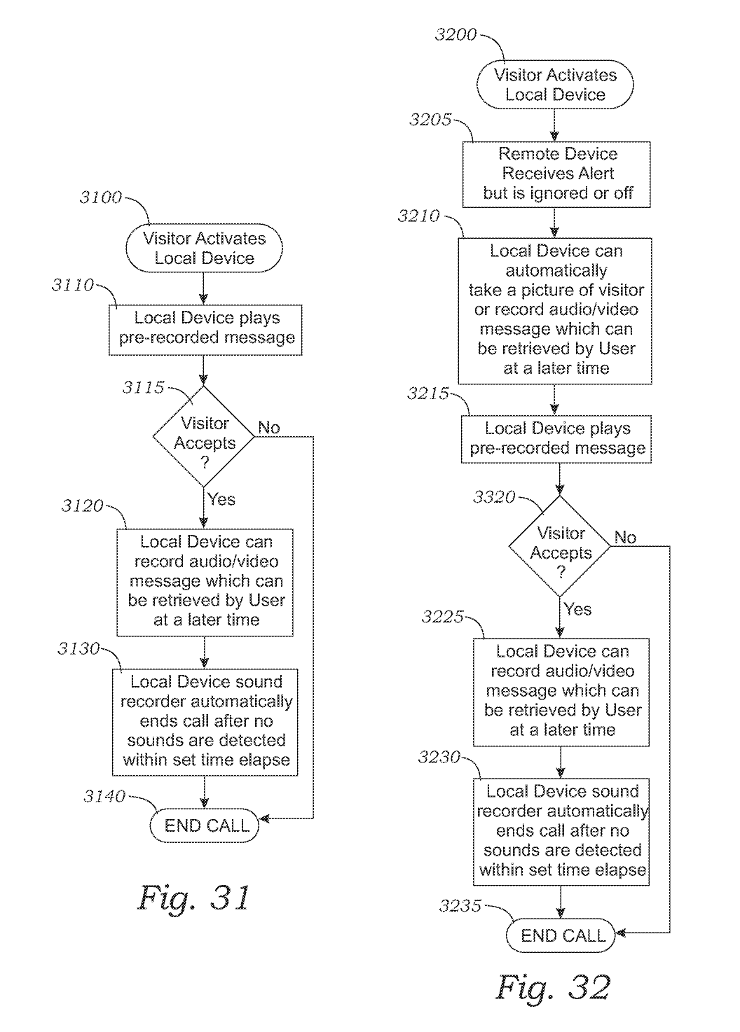

Turning now to FIG. 31, a flowchart is shown of a method of using a system in accordance with the present invention, in which a visitor activates a local device, then is presented with an option to leave a recorded message. In this manner, the local device performs a function similar to a phone answering machine. An example of when this method may be used is when the user is traveling to a non-covered cell area, or simply desires not to be bothered by notifications of visitors. Thus, the user would set an option in the local device to play a prerecorded message (which may be a single message, or selected at random or by some other algorithm from a group of pre-recorded messages).

The method begins when the visitor activates the local device (3100). The local device then plays the pre-recorded message (3110). The visitor may then opt to leave a message or not (3115). If the visitor accepts, then the local device records a video and/or audio message from the visitor (3120), and the recording may end based on time out or on sound delay (3130). The method then ends (3140). If the visitor declines, then the method ends without any recording taking place (3140).

Turning now to FIG. 32, a flowchart is shown of steps of a method of using a system in accordance with the present invention, in which a remote device is inactive. This may occur, for example, if the remote device is a cellular phone and is powered off or in a dead zone. The method begins when the visitor activates the local device (3200). The local device then sends notification to the remote device, and the remote device either receives the alert (which is ignored), or is unable to receive the alert (3205). The local device then automatically records data such as a photo or video of the visitor, and/or audio of the visitor, for transmission to the remote device and/or for storage and then later retrieval by the user (3210). Optionally, the local device may also play a pre-recorded message (3215), and the visitor may accept or decline an option to leave a message (3220). If the visitor accepts, then the local device records the data from the visitor (3225), and ends the recording as previously described (3230), after which the method ends (3235). If the visitor declines then the method ends at that time (3235).

Additional aspects of the invention will now be described, some of which are partially duplicative of the embodiments and features already described. In one aspect, the inside portion (30) of the local device (10) is set to execute a command or set of commands upon activation, such as to make a call to (or otherwise alert) the remote device (40) which can be the user's primary cell phone, and/or display a still shot or video (1000) of the visitor (101) on the viewing screen (32) of the inside portion (30) of the local device (10) itself, and/or cause the inside portion (30) of the local device (10) to emit an alert such as a ring-tone, doorbell noise, or voice alert. This can all be controlled by resident software application(s). For example, the local device application may allow calling the designated remote device (40) which may have compatible software to answer, screen a video/picture call, or otherwise process the alert. One option may be a pop-up application with preset or programmable options to select for treatment of the alert, such as ignore, leave a pre-recorded message (resident in the local device (10) or to be sent from the remote device (40)), answer (one-way or two-way audio and/or video communications), contact police, set off house alarm, etc.

In another aspect of the invention, once the user (100) is alerted of the visitor (101), the user (100) may then communicate with the visitor (101) by, for example, answering his cellular phone (remote device (40)) and talking directly to the visitor (101), whether the user (100) is at the location of the local device (10), or at a remote location. In the case where the remote device (40) is a cell phone, the user (100) would have to be in an area where coverage exists. But if not, the resident software could be programmed to detect no receiver on the other end, and store the visitor content (image, voice, etc.) for later attempted delivery and/or just at the local device (10). If stored at the local device (10), the inside portion (30) of the local device (10) could indicate an undelivered communication by means of a blinking light or other suitable means, and the resident software application would enable retrieval of same. The software could be programmed to always store visitor information, even if communication with the remote device (40) is established.

In another aspect of the invention, the user (100) may be able to view the visitor (101) in real-time via live video broadcast or still picture image (1000) transmitted by the local device (10) to the user's remote device (40) (e.g., cellular phone). This means of communication allows for the user (100) to “screen” visitors (101) using his cellular phone. The user (100) may have the option to ignore a visitor (101) and simply view the visitor (101) with his cellular phone without actually talking to the visitor (101) or allowing the visitor (101) to know he is being monitored. Should the user (100) choose to ignore the visitor (101) or be unable to answer his cellular phone, he may allow the visitor (101) to record a video message on location to be viewed at a later time.

In another aspect of the invention, the local device (10) may be programmed to automatically present to a visitor (101) a recorded message and allow the visitor (101) to leave a video recording to be viewed at a later time by the user (100).

In another aspect of the invention, when the local device (10) is activated and images and/or sounds are captured, the captured data may be stored not only locally, e.g. in the local device (10) itself, but also in an external device such as an on-site or offsite memory drive (not shown), similar to voicemail. The resident software application in the local device (10) may be set or programmed to transmit the data to such external device substantially simultaneously with capture, and/or at random, preset, or programmed intervals based on time or amount of data, and/or based on an affirmative command from the user (100) such as by selection of the option from a menu on the viewing screen (32) of the inside portion (30) of the local device (10).

In another aspect of the invention, the activation button (23 or 223) may activate the “call”/“knock” feature, and/or may be used to activate a record feature, or there may be separate buttons for these separate features. If the same button is used, then the local device (10) could be programmed or wired to know which feature to execute based on the state of the device (e.g., if it is activated from sleep mode then it would execute the “call” feature, but if it is in “transmit” mode then it would activate the “record” feature).

In another aspect of the invention, application software may be installed on the inside portion (30) of the local device (10) compatible with software running on the remote device (40), to allow the remote device (40) to receive data from the local device (10) and to control handling options automatically and/or based on user commands.

A new system and method for providing notice of visitor has thus been described, along with certain benefits and uses.

What is claimed is:

1. A local device for identifying presence of a visitor comprising:
an outside portion configured for mounting to an outside surface of an object;
an inside portion configured for mounting to an inside surface of the object; and
a connector connecting the outside portion to the inside portion;
wherein the object is selected from the group consisting of a wall and a door;
wherein the connector is configured to be embedded in the object such that the outside portion is securely mounted to the outside surface of the object and the inside portion is securely but removably mounted to the inside surface of the object;
wherein the inside portion comprises a first cell phone;
wherein the outside portion comprises an activation mechanism;
wherein the outside portion is operatively connected to the inside portion via the activation mechanism such that activation of the activation mechanism activates the inside portion causing the inside portion to transmit data to a remote device via a communication link.

2. The local device of claim 1, wherein the outside portion comprises a microphone, and the data comprises an audio signal captured by the microphone.

3. The local device of claim 1, wherein the outside portion comprises a camera, and the data comprises a video signal captured by the camera.

4. The local device of claim 1, wherein the communication link is selected from the group consisting of a cellular phone network and the Internet.

5. The local device of claim 1, wherein the outside portion comprises a microphone, a speaker, and a camera.

6. The local device of claim 5, further containing a memory with a pre-recorded message, the local device being programmed to play the pre-recorded message through the speaker upon activation of the activation mechanism.

7. The local device of claim 5, further containing a memory with a pre-recorded message, the local device being programmed to play the pre-recorded message through the speaker in response to a command transmitted to the local device from the remote device.

8. The local device of claim 1, wherein the remote device is a second cell phone.

9. The local device of claim 1, wherein the activation mechanism is selected from the group consisting of a button, a motion sensor, a vibration sensor, and a sound sensor.

10. The local device of claim 1, wherein the outside portion is securely mounted to the outside surface of the object, the inside portion is securely but removably mounted to the inside surface of the object, and the connector is substantially embedded in the object.

11. The local device of claim 1, wherein the connector comprises a threaded cylindrical tube and a corresponding oppositely threaded cylindrical mating portion to thread onto the threaded cylindrical tube.

12. A housing for securely holding a cell phone, comprising:
a substantially rectangular frame having a back side;
a back plate mounted to the back side of the frame, and configured for mounting to an outside surface of an object, wherein the object is selected from the group consisting of a wall and a door;
an amplified speaker;
a speaker jack for operatively connecting the amplified speaker to an audio signal from a cell phone mounted in the frame.

13. The housing of claim 12, further comprising a threaded cylindrical tube and a corresponding oppositely threaded cylindrical mating portion to thread onto the threaded cylindrical tube, the tube and the mating portion connected to the back plate and configured to be received by a bore in the object.

14. The housing of claim 12, further comprising a cell phone mounted in the frame, the cell phone comprising a speaker configured to transmit an audio signal to the amplified speaker.

15. A system for identifying presence of a visitor comprising:
a local device;
a remote device; and
a communication link linking the local device to the remote device;
wherein the local device comprises an outside portion securely mounted to an outside surface of a door, an inside portion securely but removably mounted to an inside surface of the door, and a connector embedded in the door and connecting the outside portion to the inside portion;
wherein the outside portion comprises an activation mechanism and is operatively connected to the inside portion via the activation mechanism such that activation of the activation mechanism activates the inside portion causing the inside portion to transmit data to the remote device via the communication link.

16. The system of claim 15, wherein the outside portion further comprises a microphone, a speaker, and a camera.

17. The system of claim 15, wherein the activation mechanism is selected from the group consisting of a button, a motion sensor, a vibration sensor, and a sound sensor.

18. A method of receiving notification of presence of a visitor at a location comprising:
receiving notification on a wireless remote device, of a visitor having activated a local device at the location;
said notification comprising data captured by the local device at approximately the time of activation, the remote device having a viewing screen;
being presented on the viewing screen options for processing the notification; and
entering a command into the remote device to select one of the options;
wherein the local device is mounted to an object selected from the group consisting of a wall and a door.

19. The method of claim 18, wherein the data comprises a video image of the visitor, and further comprising viewing the video image.

20. The method of claim 19, wherein the remote device further comprises a speaker, and wherein the data comprises a video image of the visitor and an audio signal from the visitor, and further comprising viewing the video image and listening to the audio signal.

21. The method of claim 20, wherein the command entered comprises a request to initiate a voice communication with the visitor through a communication link linking the remote device and the local device.

22. A method of processing notification of presence of a visitor at a location comprising:
identifying activation of a local device at the location indicating presence of a visitor at the location;
capturing data associated with the visitor at approximately the time of activation;
transmitting the data through a wireless network to a remote device; and
receiving a command from the remote device to establish a communication between the local device and the remote device;
wherein the local device is mounted to an object selected from the group consisting of a wall and a door.

23. The method of claim 22, wherein the data comprises a video image of the visitor.

24. The method of claim 22, wherein the data comprises a video image of the visitor and an audio signal from the visitor.
